(19) United States
(12) Patent Application Publication
(10) Pub. No.: US 2007/0164106 A1
(43) Pub. Date: Jul. 19, 2007

(54) SYSTEM FOR ONLINE ELECTRONIC RECEIPT MANAGEMENT AND METHOD THEREFOR

(76) Inventors: David Neal McDevitt, Claremont, CA (US); Andrew Alexander Dunkman, Claremont, CA (US)

Correspondence Address: WEISS & MOY PC, 4204 NORTH BROWN AVENUE, SCOTTSDALE, AZ, 85251, US

(21) Appl. No.: 11/622,933

(22) Filed: Jan. 12, 2007

Related U.S. Application Data
(60) Provisional application No. 60/758,647, filed on Jan. 13, 2006.

(51) Int. Cl. G06K 15/00; G06Q 20/00

(52) U.S. Cl. 235/383; 705/16

(57) ABSTRACT

An online electronic receipt management system and method are disclosed. The system and method allow for a centralized online electronic receipt database accessible to a user via the Internet using an email address and password to gain access to the user's unique site. The system and method also allow a user to easily organize entire sales transactions (or individual items from a multiple-item sales transaction) items into categories allow for simple calculation of total expenses relevant to that category. The system and method also allows a user to easily create gift receipts by masking certain portions of the sales transaction prior to transferring it to the recipient.

### CROSS-REFERENCE TO RELATED APPLICATION

This application claims priority to a corresponding provisional application U.S. Ser. No. 60/758,647, filed Jan. 13, 2006 in the name of the applicants of this application.

### FIELD OF THE INVENTION

This invention relates generally to receipts and, more specifically, to an online electronic receipt management system and method.

### BACKGROUND OF THE INVENTION

Millions of financial transactions occur everyday at retail stores, restaurants, service-based shops and other storefronts. The interaction between the customer and the seller is quite simple: money is exchanged for a good or service. Nearly all sellers have a company policy to issue a receipt of transaction for this good or service. These sellers have return policies which often require the customer to save the receipt in order to receive the full benefits of the return policy. Often, customers returning items or requesting refunds for the transaction are denied some or all benefits of the return policy due to the fact that they no longer have the receipt. The fact of the matter is that paper receipts are ephemeral. The entire receipt system, while serving an incredibly important purpose in the financial world, ought to be implemented in a much more effective manner.

### SUMMARY OF THE INVENTION

An object of the present invention is to provide a system and method for a centralized online electronic receipt database accessible to a user via the Internet.

It is another object of the present invention to provide a system and method wherein users can access their accounts by using an email address and password to gain access to their unique site.

It is another object of the present invention to allow a user to easily organize entire sales transactions (or individual items from a multiple-item sales transaction) items into categories, such as business expenses, gifts, tax-deductible items, etc., in order to allow for simple calculation of total expenses relevant to that category.

It is another object of the present invention to allow a user to easily create gift receipts by masking certain portions of the sales transaction, such as price of the gift item or other non-gift items, from the receipt information prior to transferring it to the recipient.

### BRIEF DESCRIPTION OF THE PREFERRED EMBODIMENTS

In accordance with one embodiment of the present invention a method for managing receipts is disclosed. The method comprises the steps of: creating a system account number on a computer system; entering the system account number into a register at a location remote from the computer system; generating receipt information by the register for at least one sales transaction; receiving the account number and the receipt information by the computer system, the account number and the receipt information transmitted from the register; storing the receipt information into a system account in a computer database, the system account being associated with the system account number; and retrieving the receipt information stored in the system account in the computer database by a system user from a location remote from the computer system. In accordance with another embodiment of the present invention, method for managing receipts is disclosed. The method comprises the steps of: creating at least one system account and associated system account number on a computer system; assigning the at least one system account and associated system account number to at least one system user; entering the at least one system account number into a register at a location remote from the computer system; generating receipt information by the register for at least one sales transaction; receiving the receipt information and the system account number by the computer system, the receipt information and the system account number transmitted from register; storing the receipt information into the at least one system account in a computer database; and retrieving the receipt information stored in the at least one system account in the computer database by the at least one system user from a location remote from the computer system.

In accordance with another embodiment of the present invention, a computer readable medium containing instructions for controlling a computer system for managing receipts is disclosed. The computer system receives receipt information transmitted from a register for at least one sales transaction; stores the receipt information in a system account in a computer database; and allows a system user to access the system account from a location remote from the computer system.

The foregoing and other objects, features, and advantages of the present invention will be apparent from the following, more particular, description of the preferred embodiments of the invention, as illustrated in the accompanying drawings.

### BRIEF DESCRIPTION OF THE DRAWINGS

FIG. 1 is a simplified functional block diagram of the system of the present invention.

FIG. 2 is a schematic of a user interface.

FIG. 3 is a sample list of receipts (sales transactions) saved in a user's account on the system database.

FIG. 4 is a sample list of group folders in a user's account on the system database.

FIG. 5 is a sample list of receipts categorized in a folder in a user's account on the system database.

FIG. 6 is a sample receipt saved in a user's account on the system database.

FIG. 7 is a sample receipt transfer form.

FIG. 8 is a schematic of a seller/retailer interface.

### DETAILED DESCRIPTION OF THE PREFERRED EMBODIMENTS

The novel features believed characteristic of the invention are set forth in the appended claims. The invention will best be understood by reference to the following detailed description of illustrated embodiments when read in conjunction with the accompanying drawings, wherein like reference numerals and symbols represent like elements.

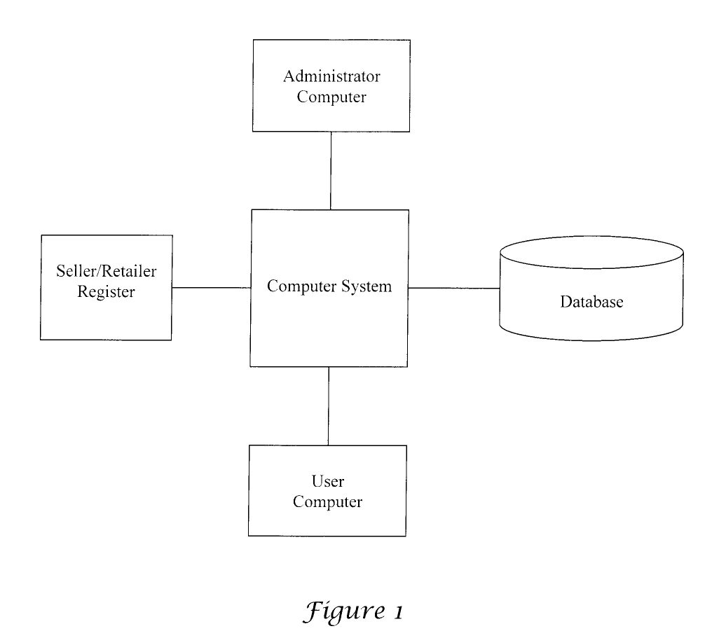

FIGS. 1-8 disclose a system and method for online electronic receipts. As shown in FIG. 1, the system is preferably accessible by an administrator, sellers/retailers, and users (e.g. users). Preferably, the administrator, seller/retailer, and the user may access the system from remote locations.

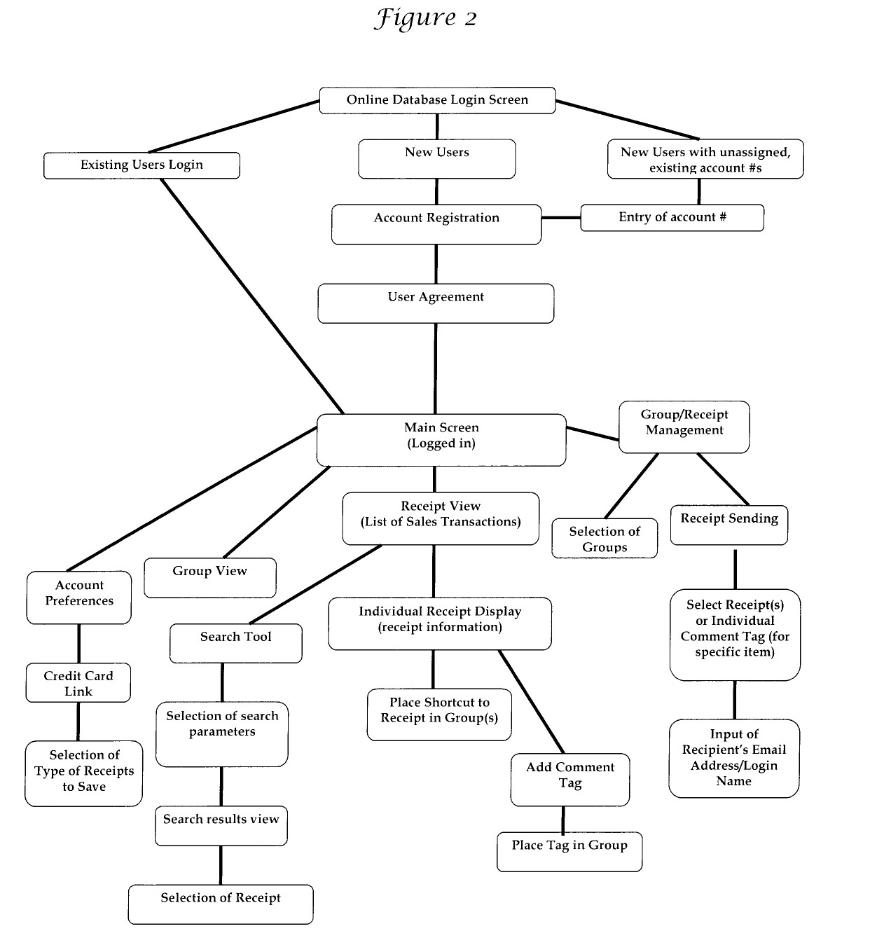

Referring to FIGS. 2-7, a user visiting the website of the online database may sign up for a system account. Preferably, users may use the system at no cost, but it should be clearly understood that substantial benefit may be derived from users having to pay membership fees. The administrator then preferably issues a unique system account number to the user so that any information submitted to the system under this system account number would be posted to the corresponding user's account.

After registering, the user will receive via mail a plastic user card that has a magnetic strip encoded with his/her system account number as well as the system account number printed thereon. The system account number encoded in the strip is the same system account number that was assigned to the user. It is possible that the system account number encoded in the magnetic strip may be encrypted. Electronic receipt submission software (discussed below) installed on any seller/retailer register will use the magnetic strip to recognize the user. Should the participating seller not have the capability to read the magnetic strip, the software will also have the ability to accept a manually entered system account number in place of swiping the magnetic strip.

Alternatively, users may also sign up for a system account through a participating seller/retailer. For example, user cards with the magnetic encoded strip may be available at the seller/retailer register and these user cards will have unassigned system account numbers which have yet to be registered to a new user. If a user desires to open a system account, an unassigned user card may be scanned so that the register will send the receipt information to the computer system which will then be stored in the system computer database. Later, the user may sign onto the system online and complete the registration process by inputting the number on the user card. Once the registration is complete, the receipt(s) which have been saved using the unassigned user card and the system account number will appear in the user's receipt account. The user could continue to use the unassigned system account and user card for as long as he/she likes, but would not be able to retrieve the receipts online until he/she registers as a member. This mechanism allows any user to begin using the service at a retail store the moment he/she learns about it as opposed to having to go online to sign up.

Another way for the users to store their receipts in the electronic receipt database would be to have their credit/debit cards linked to the system. Upon registration, the users would be given the option to select credit/debit cards to be linked to the system. When a user submits the information to the database, the database contacts the corresponding credit/debit card service to confirm that the credit/debit card is in fact valid and authorized to the user. From then on, every time the user completes a transaction with that credit/debit card at a participating seller with the appropriate register software, a copy of the receipt will be saved on the system database. The register would communicate with the credit/debit card service for authorization purposes. If the credit/debit card is registered on the system, then the credit/debit card service will send the register the payment authorization as well as the system account number so that the register software will recognize the user and send the receipt information to the system database. Though not required, it is preferable that the system administrator have a licensing agreement with the respective financial service.

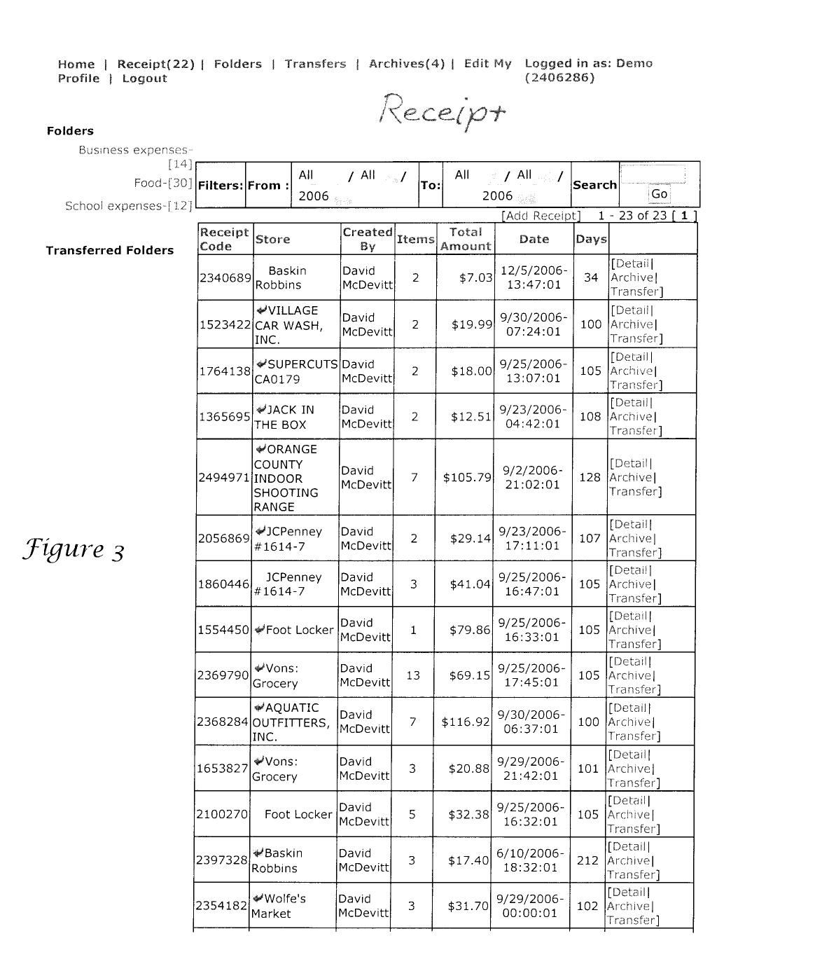

Users may access their accounts online via an html browser using the user's email address as a login name and a password chosen by the user at the time of registration. In the system database, it is preferred that all of the user's sales transactions (receipts) be logged by date, price of transaction, and kind of transaction (see FIG. 3). For example, receipts for items purchased at grocery store would be recognized as “Food” by the database and the member could sort his/her receipts in this manner. If the user simply wanted to look at his transactions that were above $100, he could view his receipts according to the corresponding price threshold. The user could also view the receipts by date and time of day.

If the user has opted to link his/her credit cards to the system, he/she then has the option of choosing which types of receipts he/she would like saved, or which types he/she would specifically not like to have saved. For example, he/she could elect to save all receipts which total more than $50, or could decide to not save any receipts from fast food sellers, as specific receipts may be more or less useful to him/her. He/she could also have different types of transactions saved for each card. If the user had an expense account, then he/she would want all of his transactions saved on one of his/her cards, but would want to save only certain receipts on the rest of his/her cards. If it were the user's company who issued the card, that company too could register the card on its own system account to access the purchase information made on its employee's expense account.

Each receipt would preferably be stored as a text file, rather than as an image file. It follows that the user could search his/her account for receipts using a search function, and could even specify which dates or types of transactions to view, so as to narrow the search. For example, a user who purchased a set of tires from an automotive supplies store could find his/her receipt (should the tires fail) by searching the word “tire” under the “Automotive” category (not shown), or he/she could specify between which dates he/she thinks he/she may have purchased the tires. Because of these search and sorting features, the user could look up transactions made months or years earlier with relative ease.

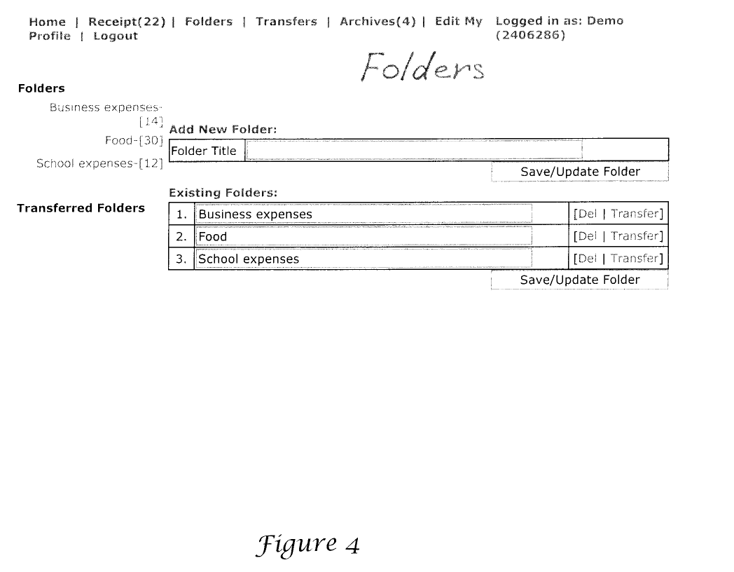

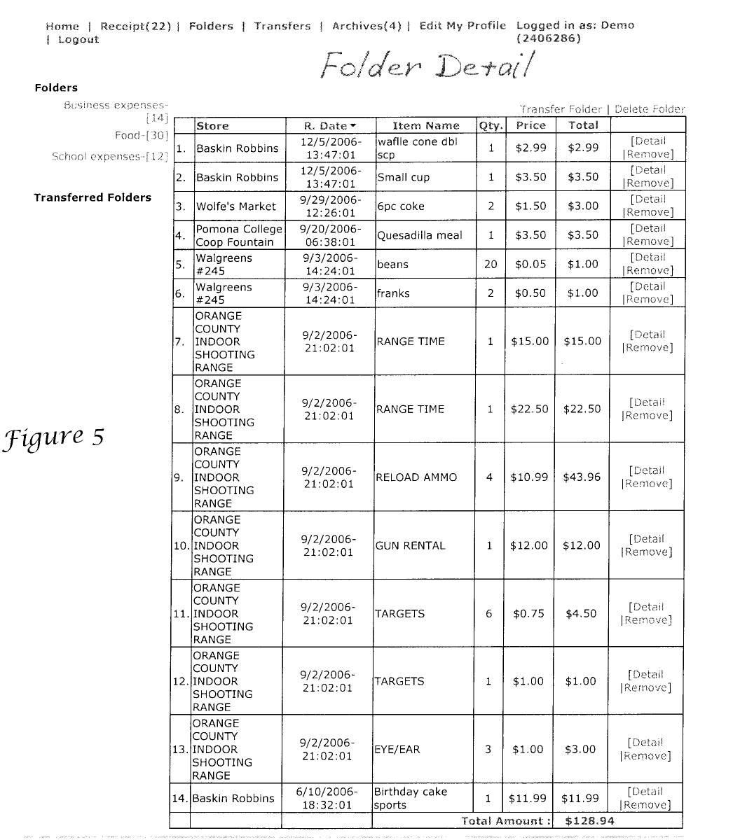

In addition to having the receipts sorted by purchase type, the user can also create his/her own receipt group folders, as shown in FIG. 4. FIG. 5, for example, shows receipts categorized under the “Food” folder. These groups can be created for the user's convenience in order to better organize the information stored in his/her account. Preferably, placing a receipt into a group would not move the receipt file into a new folder, but would simply represent the receipt, so that the receipts all stay in the same section. For example, if a user purchases a meal at a restaurant and wants to later declare it as a business expense, he/she would create a group called “Business Expenditures.” Then he/she would select the restaurant receipt to view. Once the receipt is in view, he/she may select an individual item or multiple items that he/she wishes to move to the Business Expenditures folder. From a list of group folders, he/she will choose the Business Expenditures folder and then move the selected item(s) into it.

Another feature of the system would be to allow the user to place “comment tags” in the receipts, so as to leave himself/herself comments regarding specific items on the receipt. For example, if a user purchases several items at one store, but wants to remember specific facts about a purchase (e.g. that the coffee maker was for Aunt Sally's birthday), he/she use a text box to store comments about the purchase.

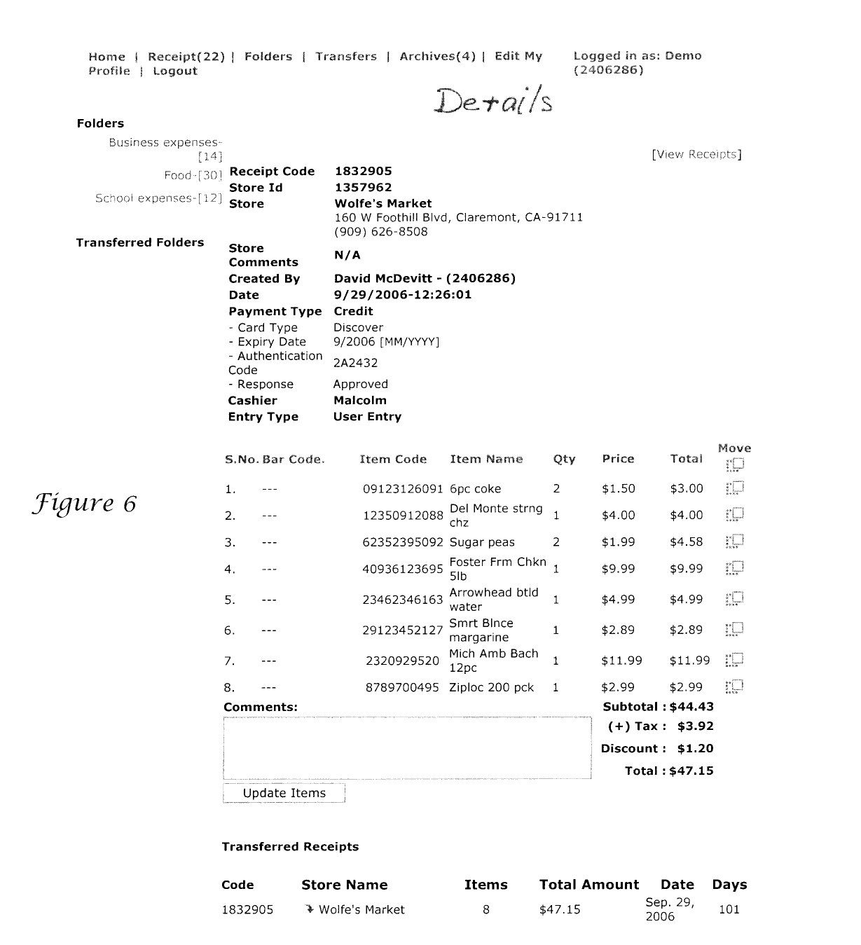

Preferably, the system will automatically read the subtotal field on each receipt in any group (see FIG. 6). Once receipts have been placed into groups, the system will further preferably aggregate the subtotals and show the user how much he/she has spent on items in that group. This will allow the user to know how much he/she has spent on certain types of expenditures, like “Groceries,” “Electronics” or any created groups like “Receipts for Charity X.”

If a single item (or possibly more) from a receipt with multiple items has been placed into a group folder, then the system will recalculate the total amount spent on the specific item which has been directed towards that group and use the same sales tax rate as was used in generating the receipt. The database will do this by reading the tax and total fields, as well as the cost of each individual item.

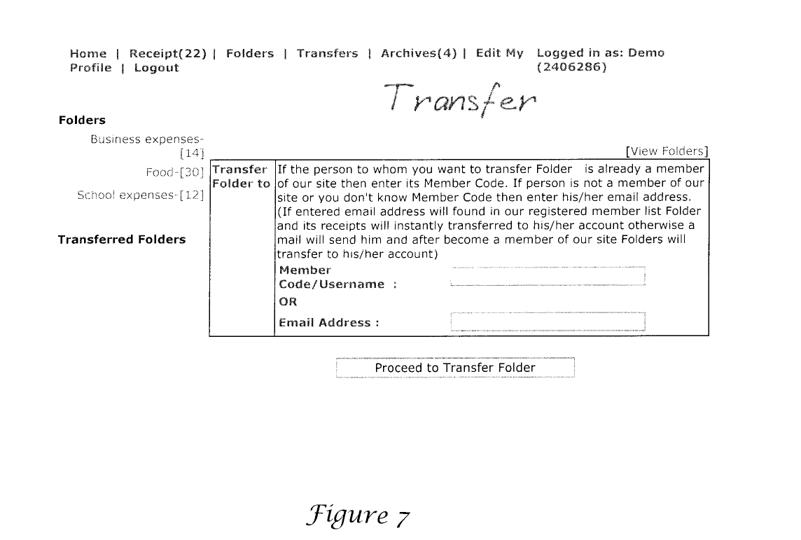

Referring to FIG. 7, each system user will be able to send copies of receipts to other system users, as long as he/she knows the email address that the other person(s) uses to access the system. If the other person he/she wishes to send the receipt to does not have an account, it will be sent as an email to the specified email address. The downside of having the receipt as an email would be that it is not stored permanently in the database. The receipts that a participating user receives would be deposited into a separate group. This feature has multiple purposes. It can be used to send one another gift receipts for specific items, by checking “Gift Receipt” (not shown) and designating which item on the receipt is the actual gift. In the case of a multiple item receipt, the user would be able to check “Gift Receipt” on multiple items if appropriate. Preferably, the gift receipt option would not disclose any items except those which the user wants the receiver to see. He/she would have the option to mask the total amount of the receipt or the amount which he/she paid for the item. When the receiver takes the item back to the store of purchase, the store will swipe the user card with the uniquely encoded magnetic strip or manually enter the account number on the user card, and the gift receipt will appear on his/her account as if it were he/she who made the transaction.

The ability to send one another copies of receipts can also facilitate the declaration of business expenditures. Not only could the user save copies of the receipts for printing at a later time, the user could also send the receipts to the reimbursing party's own account, to save time and effort. This could facilitate many different types of group functions, like fundraising organizations. For example, each member of a charity group could make the necessary purchases for a fundraiser and send the electronic receipts to the group treasurer, rather than run the risk of losing their receipt and the refund. Should a state or federal government approve the service, users could also submit receipts to a central internal revenue service as proof of purchase. This, however, would not be possible with receipts that are submitted as an email, because email documents can be modified, but the electronic receipts cannot. Users can only opt to omit certain information, not change the text of the receipt. This would ensure the validity of the document since it is “read-only.”

In order for the online electronic receipt database to function properly, sellers/retailers need to be able to send packets of information through telephone lines or via an Ethernet connection to the computer system which stores the information on the database. To do this, the seller/retailer's register, which generates the paper receipt, must have the appropriate software installed. Due to the wide variations in the functionality of different registers, there would be some registers which could perform some, but not all of the tasks explained below. Each register would be programmed to perform as many functions as possible, but the most capable of all registers will be disclosed herein in order to describe all of the features.

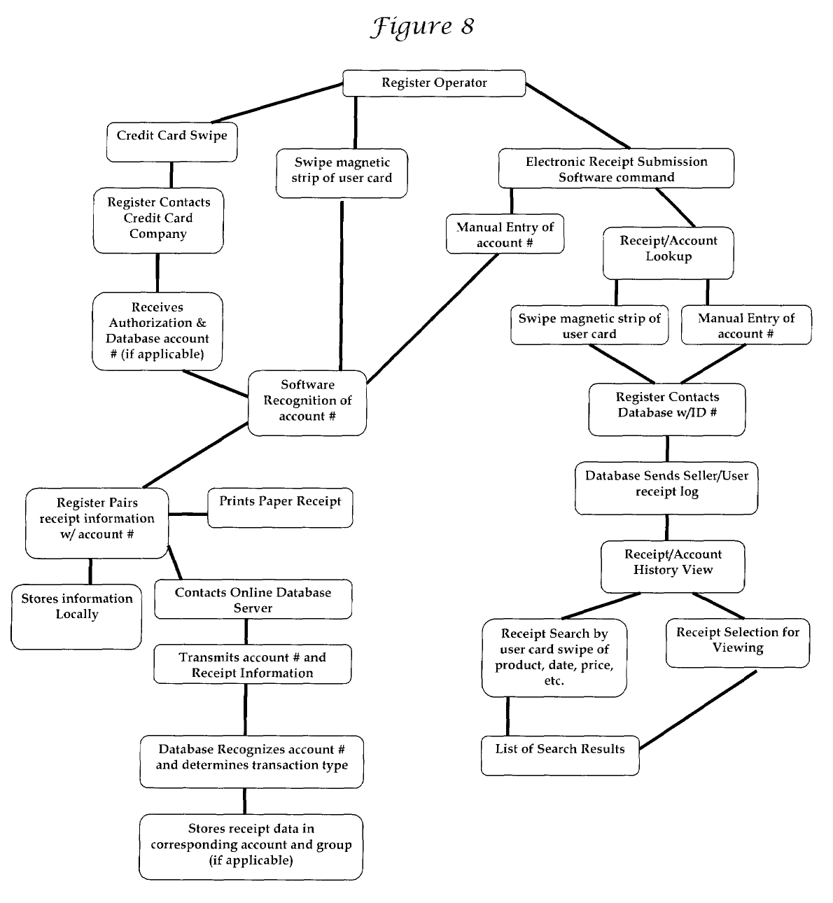

Referring to FIG. 8, the software installed on the registers of participating retail stores and other sellers would be designed such that entering specific keys (e.g. ctrl+2) would prompt the operator of the register to either manually enter the system account number of the customer or to swipe the magnetic strip of the customer's user card. Once the computer recognizes the system account number of the customer, it uses its dedicated telephone line (which it might also use to process credit card transactions) to call the system. After it connects, it will send the system the system account number so the system knows where to store the information in the database. It will then send the information that it generates for printing the receipt to the database as text information. Preferably, nothing from the receipt will be left out. If the receipt includes the store's hours and location, then it will all be transmitted to the system for storage in the database. Frequently, stores print out additional information to give to the customer, such as rebate and warranty information. This may also be transmitted and stored along with the receipt in the same file in the database.

When a customer returns to a seller with a product and his user card, the employee operating the register will access the electronic receipt software using whatever specified command might have been assigned and select the “receipt retrieval” option. Then the register operator will either swipe the magnetic strip on the customer's user card or the register operator will enter the customer's system account number that is shown on the tag if the register does not have magnetic strip reader.

The software program will then preferably show a list of all of the transactions that the customer has made using his electronic receipt database account. There will be also preferably be a feature that allows the register operator to select a timeframe within which to search. This would be in the event that the customer has many receipts on file and viewing each one would be rather slow. The program will also have an item search feature, so that the operator could pull up the customer's electronic receipt database account and then either scan or type in the UPC code on the purchased product itself, if applicable. This would help to expedite the process so as to save time for those waiting in line.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A method for managing receipts comprising the steps of:
creating a system account number on a computer system;
entering said system account number into a register at a location remote from said computer system;
generating receipt information by said register for at least one sales transaction;
receiving said account number and said receipt information by said computer system, said account number and said receipt information transmitted from said register;
storing said receipt information into a system account in a computer database, said system account being associated with said system account number; and
retrieving said receipt information stored in said system account in said computer database by a system user from a location remote from said computer system.

2. The method of claim 1 further comprising the step of assigning said system account and said associated system account number to said system user at a location remote from said computer.

3. The method of claim 1 wherein said receipt information being stored as a text file in said computer database.

4. The method of claim 1 further comprising the step of retrieving said receipt information stored in said computer database by said register for performing one of a return and an exchange of at least one item purchased during said at least one sales transaction.

5. The method of claim 1 further comprising the step of organizing said receipt information by at least one of said computer system and said system user into groups according to at least one of purchased item type, transaction type, transaction date, and transaction amount.

6. The method of claim 5 further comprising the step of calculating by said computer system total expenditures for any of said groups.

7. The method of claim 1 further comprising the step of adding to said receipt information by said system user at least one comment about any item purchased during said at least one sales transaction.

8. The method of claim 1 further comprising the steps of:
creating at least another system account; and
transferring said receipt information from said system account to said at least another system account by said system user from a location remote from said computer system.

9. The method of claim 8 further comprising the step of masking at least a portion of said receipt information by said first system user prior to transferring said receipt information.

10. The method of claim 1 further comprising the step of transferring said receipt information from said system account to at least one electronic mail address by said system user from a location remote from said computer system.

11. A method for managing receipts comprising the steps of:
creating at least one system account and associated system account number on a computer system;
assigning said at least one system account and associated system account number to at least one system user;
entering said at least one system account number into a register at a location remote from said computer system;
generating receipt information by said register for at least one sales transaction;
receiving said receipt information and said system account number by said computer system, said receipt information and said system account number transmitted from said register;
storing said receipt information into said at least one system account in a computer database; and
retrieving said receipt information stored in said at least one system account in said computer database by said at least one system user from a location remote from said computer system.

12. The method of claim 11 further comprising the steps of:
organizing said receipt information by at least one of said computer system and said at least one user into groups according to at least one of purchased item type, purchase type, purchase date, and purchase amount; and
calculating by said computer system total expenditures for any of said groups.

13. The method of claim 11 further comprising the step of transferring said receipt information from said at least one system account to one of another system account and an electronic mail address from a location remote from said computer system.

14. The method of claim 13 further comprising the step of masking at least a portion of said receipt information prior to transferring said receipt information.

15. A computer readable medium containing instructions for controlling a computer system for managing receipts that:
receives receipt information transmitted from a register for at least one sales transaction;
stores said receipt information in a system account in a computer database; and
allows a system user to access said system account from a location remote from said computer system.

16. The computer readable medium of claim 15 wherein at least one of said computer system and said system user organizes said receipt information into groups according to at least one of type of item purchased during said sales transaction, sales transaction type, sales transaction date, and sales transaction amount.

17. The computer readable medium of claim 16 wherein said computer system calculates total expenditures for any of said groups.

18. The computer readable medium of claim 15 wherein said computer system allows a system user to add comments to said receipt about any item purchased during said sales transaction.

19. The computer readable medium of claim 15 wherein said computer system allows a system user to transfer said receipt information from said system account to at least one of another system account and an email address.

20. The computer readable medium of claim 19 wherein said computer system allows said system user to create a gift receipt by masking any portion of said receipt information prior to transferring said receipt information.
